(19) United States
(12) Patent Application Publication
(10) Pub. No.: US 2008/0171392 A1
(43) Pub. Date: Jul. 17, 2008

(54) IN SITU TEST FOR DETERMINING DRUG HISTORY

(75) Inventor: J. Jennifer Wu, Arkadelphia, AR (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: BOARD OF TRUSTEES OF THE UNIVERSITY OF ARKANSAS, Little Rock, AR (US)

(21) Appl. No.: 12/013,558

(22) Filed: Jan. 14, 2008

Related U.S. Application Data
(60) Provisional application No. 60/884,689, filed on Jan. 12, 2007.

(51) Int. Cl. G01N 31/22; G01N 37/00; C01B 21/00

(52) U.S. Cl. 436/2; 436/125; 423/395

(57) ABSTRACT

The present invention relates generally to kits, compositions and methods useful in the qualitative analysis of the presence of chemicals used and produced in the manufacture of illegal drugs. The compositions and methods may be useful for, among other things, qualitatively determining whether items of real or personal property or other chattels have been exposed to the manufacture of illegal drugs or whether such items have been contaminated by illegal drugs.

### BACKGROUND OF THE INVENTION

Methamphetamine (C₁₀H₁₅N; N-methyl-1-phenyl-propan-2-amine; molecular weight 149.2; CAS No. 53746-2) is a member of the family of stimulant drugs known as amphetamines. Methamphetamine may be produced as either a d- or l-optical isomer. The d-isomer is a potent central nervous system stimulant used primarily for recreational purposes. d-Methamphetamine is sometimes prescribed under the brand name Desoxyn® for treatment of conditions such as obesity, attention-deficit-hyperactivity-disorder and narcolepsy. The l-isomer is an ingredient in some nasal decongestants and is much less potent than the d-isomer.

d-Methamphetamine is the preferred isomer of illegal drug manufacturers and illegal methamphetamine users because d-methamphetamine, sometimes referred to as “speed,” “chalk,” “christy,” or “crank,” is more soluble than other members of the amphetamine family, it enters the brain quickly to produce euphoria and the euphoric effects persist for many hours. The odorless, bitter-tasting powder may be used according to numerous methods including, but not limited to, smoking, injection, and oral ingestion. Acute, or short-tem, peripheral effects include increases in blood pressure, palpitations, and dryness of the mouth. Overdose of methamphetamine may cause hallucinations, depression, skeletal muscle atrophy, and a schizophrenia-like state. Chronic, or long-term, effects of methamphetamine use may include psychosis, disturbed sleep patterns, and inability to think clearly.

Illegal d-methamphetamine manufacturers may use any of several known methods of manufacture including the ephedrine/pseudoephedrine reduction method of methamphetamine production. Chemicals that are commonly utilized in this method may include, among other chemicals, ephedrine, hydriodic acid, and red phosphorous. The stages of the manufacturing process yield intermediate chemical compounds. Multi-pound quantities of high-quality d-methamphetamine may be produced through this method. However, production of a small amount of methamphetamine may create significant quantities of chemical waste and vapors. Long after the methamphetamine laboratory is dismantled, residual chemical precursors, intermediates, products and waste byproducts may remain.

Manufacturers of illegal d-methamphetamine often produce the drug in clandestine laboratories. These laboratories may be located in various places including places such as houses, trailers, storage facilities, apartment complexes or other edifices. In some instances, clandestine laboratories may be located in mobile structures such as automobiles, campers, tractor trailers, mobile homes, recreational vehicles or other types of vehicles. All of the structural elements, interior fixtures and furnishings of a clandestine laboratory may be contaminated by the chemical precursors, intermediates, products and waste byproducts of the manufacturing process. These structural elements, interior fixtures and furnishings may be, for example, walls, floors, ceilings, furniture, appliances, carpeting, clothing, interior upholstery, decorative elements or functional elements.

Currently, an owner of real or personal property or other chattels must bear the full financial burden of cleaning the toxic compounds that remain in or on items exposed to the manufacturing process. Recommended cleanup methods may include removal of all items to be cleaned off-site; replacement of building materials that have been greatly affected; a wash of all exposed surfaces; and surface wipe samples to be sent to a crime lab for specialized analysis. Furthermore, some health agencies suggest that remediation is not complete unless there is less than 0.5 μg (micrograms) of methamphetamine residue per square foot. This procedure may range in cost from $5.000 to $150,000 or more, depending on the nature of the materials affected by the manufacturing process, the extent of the damage and the diffusion of contaminants.

Because the costs are so great for remediation of clandestine laboratory sites, property owners, such as a lessor, may not report a methamphetamine lab on their property. Because the odor of a clandestine methamphetamine lab fades with time, potential acquirers of property may be unaware that the property contains more than trace percentages of harmful chemicals including, but not limited to, methamphetamine. Within days of exposure, the purchaser or tenant may experience the same symptoms that affect methamphetamine manufacturers or methamphetamine users. Methamphetamine and many of the reagents used in clandestine methamphetamine laboratories create an inhalation hazard. Additionally, methamphetamine and other chemicals from the manufacturing process may remain on surfaces where they can be contacted and absorbed through the skin, eyes, mouth, nose or through some other means.

There are numerous byproducts of methamphetamine production. One of the key components of many methamphetamine manufacturing processes is hydriodic acid (HI; molecular weight 127.91; CAS No. 10034-85-2). At the site of a clandestine methamphetamine laboratory, hydriodic acid vapors may become deposited on or seep into various items and linger for an indefinite period of time. The volatility of hydriodic acid is low enough that hydriodic acid residue is a good indicator of methamphetamine production and presence even after an extended period of time. Hydriodic acid is not a common chemical in household goods. It is also not primarily associated with other drugs. Therefore, the presence of hydriodic acid within items of real or personal property or other chattels may qualitatively indicate the presence of methamphetamine and other chemicals associated with the manufacture of methamphetamine.

Potential acquirers of real or personal property or other chattels generally do not have access to analytical tests for detection of contamination. Current methods of detection require professional analysis techniques utilizing equipment costing thousands of dollars. Examples of the types of detection and identification methods include, for example, enantiomeric determination using solid-phase microextraction, gas chromatography and high-resolution mass spectrometry, gas chromatography in combination with flame ionization detection, and X-ray spectrometry. Clearly, equipment and technological know-how necessary to conduct these types of assays are not readily available to the general public at a reasonable price.

### BRIEF SUMMARY OF THE INVENTION

Most owners, possessors or potential acquirers of real property, personal property or other chattels are unaware of the possible presence of drug manufacture contaminants in or on the property. These drug manufacture contaminants may include chemicals such as methamphetamine, hydriodic acid or other chemical precursors, intermediates, products or byproducts associated with illegal drug manufacture. Additionally, there are no affordable, discrete tests indicating methamphetamine presence or the presence of drug manufacture contaminants to place owners, possessors or acquirers on notice of the contamination. The present invention provides a cost-effective kit and methods of methamphetamine detection directly usable by owners, possessors or acquirers of real property, personal property or other chattels. The methods are simple and provide results in situ.

In one embodiment of the present invention, the inventors have provided a reagent for detecting exposure to drug manufacture comprising a hydriodic acid detection agent.

In one embodiment of the present invention, the inventors have provided a method for detecting exposure of an item to drug manufacture comprising detecting hydriodic acid in or on said item.

In one embodiment of the present invention, the inventors have provided a method for identifying methamphetamine contamination in or on an item comprising detecting hydriodic acid in or on said item.

In another embodiment of the present invention, the inventors have provided a kit for detecting exposure to drug manufacture comprising a hydriodic acid detection agent.

### BRIEF DESCRIPTION OF THE DRAWINGS

FIG. 1 illustrates the basic grid utilized for testing the reagents and methods disclosed herein on various materials. In each experiment, a subject material was sectioned as illustrated. Various solvents were utilized in each quadrant for sample collection. Quadrant II served as the control quadrant. Quadrant III served as a test quadrant in which the solvent was isopropyl alcohol. Quadrant IV served as a test quadrant in which the solvent was distilled water. Quadrant I served as a test quadrant in which the solvent was household glass cleaner with ammonia.

FIG. 2 illustrates the color development chart. Upon development of a test sample, the color of the test sample may be compared to the color development chart and the tested sample may be assigned a number corresponding to the strength of the color developed.

FIGS. 3A and 3B illustrate the results of duplicate tests to detect the presence of hydriodic acid on unpainted plywood using silver nitrate as the indicator.

FIG. 3C illustrates an exemplary color indication for detection of 0.1M HI on unpainted plywood using distilled water as a solvent and 1.00% silver nitrate as the indicator.

FIG. 3D illustrates an exemplary color indication for detection of 0.01M HI on unpainted plywood using glass cleaner as a solvent and 4.00% silver nitrate as the indicator.

FIGS. 4A and 4B illustrate the results of duplicate tests to detect the presence of hydriodic acid on unpainted sheetrock using silver nitrate as the indicator.

FIGS. 5A and 5B illustrate the results of duplicate tests to detect the presence of hydriodic acid on unpainted ceiling board using silver nitrate as the indicator.

FIGS. 6A and 6B illustrate the results of duplicate tests to detect the presence of hydriodic acid on painted plywood using silver nitrate as the indicator.

FIGS. 7A and 7B illustrate the results of duplicate tests to detect the presence of hydriodic acid on painted sheetrock using silver nitrate as the indicator.

FIG. 7C illustrates an exemplary color indication for detection of 1.0M HI on painted sheetrock using isopropyl alcohol as a solvent and 0.50% silver nitrate as the indicator.

FIGS. 8A and 8B illustrate the results of duplicate tests to detect the presence of hydriodic acid on painted ceiling board using silver nitrate as the indicator.

FIG. 8C illustrates an exemplary color indication for detection of 1.0M HI on painted ceiling board using distilled water as a solvent and 0.50% silver nitrate as the indicator.

FIGS. 9A and 9B illustrate the results of duplicate tests to detect the presence of hydriodic acid on unpainted plywood using starch as the indicator.

FIG. 9C illustrates an exemplary color indication for detection of 0.1M HI on unpainted plywood using isopropyl alcohol as a solvent and 4.00% starch as the indicator.

FIG. 9D illustrates an exemplary color indication for detection of 1.0M HI on unpainted plywood using distilled water as a solvent and 2.00% starch as the indicator.

FIGS. 10A and 10B illustrate the results of duplicate tests to detect the presence of hydriodic acid on unpainted sheetrock using starch as the indicator.

FIGS. 11A and 11B illustrate the results of duplicate tests to detect the presence of hydriodic acid on unpainted ceiling board using starch as the indicator.

FIG. 11C illustrates an exemplary color indication for detection of 1.0M HI on unpainted ceiling board using isopropyl alcohol as a solvent and 6.00% starch as the indicator.

FIGS. 12A and 12B illustrate the results of duplicate tests to detect the presence of hydriodic acid on painted plywood using starch as the indicator.

FIG. 12C illustrates an exemplary color indication for detection of 1.0M HI on painted plywood using isopropyl alcohol as a solvent and 6.00% starch as the indicator.

FIGS. 13A and 13B illustrate the results of duplicate tests to detect the presence of hydriodic acid on painted sheetrock using starch as the indicator.

FIG. 13C illustrates an exemplary color indication for detection of 1.0M HI on painted sheetrock using distilled water as a solvent and 2.00% starch as the indicator.

FIG. 13D illustrates an exemplary color indication for detection of 1.0M HI on painted sheetrock using isopropyl alcohol as a solvent and 4.00% starch as the indicator.

FIG. 13E illustrates an exemplary color indication for detection of 0.01M HI on painted sheetrock using isopropyl alcohol as a solvent and 2.00% starch as the indicator.

FIGS. 14A and 14B illustrate the results of duplicate tests to detect the presence of hydriodic acid on painted ceiling board using starch as the indicator.

### DETAILED DESCRIPTION

The present inventors have developed reagents, methods and kits for the detection of exposure to illegal drug manufacture. The reagents, methods and kits of the present invention allow an acquirer, potential acquirer or possessor of property to analyze the exposure of said property to illegal drug manufacture. An acquirer of property may be, for example, a purchaser, a lessee, a donee or a person otherwise obtaining possession of an item. An item may be any piece of property including, for example, real property and the improvements thereto. An item may also be any piece of personal property including, for example, motorized vehicles and vehicle accessories, trailers, furniture, household furnishings, fixtures, home decor or any other type of personal property or chattel.

The reagents, methods and kits of the present invention allow an acquirer, potential acquirer or possessor of property to analyze the exposure of said property to illegal drug manufacture. A user of the present invention may identify chemical contamination in or on any item, including chemical contamination by illegal drugs, reagents used in illegal drug manufacture or byproducts of the illegal drug manufacture.

Specifically, one embodiment of the present invention is a reagent for detecting exposure to drug manufacture comprising a hydriodic acid detection agent. Hydriodic acid is a common reagent utilized during drug manufacture and contaminates items exposed to the manufacture process. Detection of hydriodic acid may be indicative of exposure to drug manufacture and contamination with other chemicals including, for example, illegal drugs such as methamphetamine. A hydriodic acid detection agent of the present invention may be selected from the group consisting of starch and silver nitrate.

Starch and hydriodic acid react as follows:

Starch (C₆H₁₀O₅)+Hydriodic Acid (HI_{(aq)}): Starch−Iodine Complex

The interaction of the iodine within the polysaccharide starch chain creates a complex that may be visualized as a vivid blue-black color. In some instances, the color reaction results in a more red-purple appearance due to the structure of the starch and iodine complex.

In various embodiments of the present invention, the hydriodic acid detection agent may comprise a starch solution. Said starch solution may have a starch concentration of approximately 1.0 percent starch by weight, approximately 1.5 percent starch by weight, approximately 2.0 percent starch by weight, approximately 2.5 percent starch by weight, approximately 3.0 percent starch by weight, approximately 3.5 percent starch by weight, approximately 4.0 percent starch by weight, approximately 4.5 percent starch by weight, approximately 5.0 percent starch by weight, approximately 5.5 percent starch by weight, or approximately 6.0 percent starch by weight. The starch solution may have a starch concentration within or beyond the stated ranges that are within the scope of this invention.

Silver nitrate and hydriodic acid may react according to the following chemical reaction:

AgNO_{3(aq)}+HI_{(aq)}→AgI₍₅₎+HNO_{3(aq)}

One product of the reaction is AgI₍₅₎ which forms as a yellow precipitate. Thus silver nitrate may be used as a hydriodic acid detection agent.

In various embodiments of the present invention, the hydriodic acid detection agent may comprise a silver nitrate solution. Said silver nitrate solution may have a silver nitrate concentration of approximately 0.50 percent silver nitrate by weight. approximately 1.00 percent silver nitrate by weight, approximately 1.50 percent silver nitrate by weight, approximately 2.00 percent silver nitrate by weight, approximately 2.50 percent silver nitrate by weight, approximately 3.00 percent silver nitrate by weight, approximately 3.50 percent silver nitrate by weight, or approximately 4.00 percent silver nitrate by weight. The silver nitrate solution may have a silver nitrate concentration within or beyond the stated ranges that are within the scope of the present invention.

In various embodiments of the present invention, the drug manufacture is methamphetamine manufacture.

The present invention also provides a method of detecting exposure of an item to drug manufacture comprising detecting hydriodic acid in or on said item. Accordingly, the hydriodic acid may be detected directly on said item of interest. However, if hydriodic acid is present, detection on the item of interest may result in a stain in or on said item.

Alternatively, a sample may be obtained from the item to be analyzed. Sample collection can occur with or without application of a solvent to the item. Solvents that may be suitable in various embodiments of the present invention include solvents such as, for example, distilled water, isopropyl alcohol, acetone, ethanol, methanol, and household glass cleaner. Household glass cleaner can be any household glass cleaner such as Windex™ with ammonia or Great Value glass cleaner.

A sample may be collected from an item by various techniques including, but not limited to, swabbing, wiping, and scraping. Sample collection can occur with or without prior application of a solvent to the item to be sampled. Sample collection may also employ a sample collection device such as, for example, filter paper, gauze, cotton, and chromatography paper.

Subsequent to sample collection, a reagent for detecting exposure to drug manufacture is contacted with the sample. The reagent for detecting exposure to drug manufacture may comprise a hydriodic acid detection agent. The hydriodic acid detection agent may be selected from the group consisting of starch and silver nitrate. The hydriodic acid detection agent may be a starch solution or silver nitrate solution as previously described. Contacting the sample with the reagent for detecting exposure to drug manufacture may result in the development of a color indicator. For example, upon contacting the sample with a starch solution of the present invention, a blue-black or red-purple color may be detected. Alternatively, upon contacting the sample with a silver nitrate solution of the present invention, a yellow color may be detected. Either such color development may indicate the presence of hydriodic acid and exposure to drug manufacture. Particularly, such drug manufacture may be methamphetamine manufacture.

The aforementioned method is not only applicable to the detection of hydriodic acid, but it is also applicable to the detection of methamphetamine contamination. The presence of hydriodic acid in or on an item may be indicative of contamination of that item with methamphetamine, reagents for methamphetamine manufacture or byproducts of methamphetamine manufacture. Therefore, one embodiment of the present invention includes a method of detecting methamphetamine contamination on an item comprising contacting a hydriodic acid detection agent to a sample from the item and observing development of a color indicator.

Additionally, the technique of the aforementioned method may be applied for the general detection of hydriodic acid contamination. Thus, the present invention also includes a method of detecting hydriodic acid comprising contacting a hydriodic acid detection agent to a sample and observing development of a color indicator.

In a particular configuration, the present invention includes a kit for detecting exposure to drug manufacture comprising a hydriodic acid detection agent. The kit may further comprise a solvent wherein said solvent may be selected from the group consisting of distilled water, isopropyl alcohol, acetone, ethanol, methanol, and household glass cleaner. Additionally, the kit may further comprise a sample collection device wherein said sample collection device comprises a swab and may be selected from the group consisting of filter paper, gauze, cotton, and chromatography paper. Also, the kit may further comprise a reference color development chart and may comprise instructions. The kit of the present embodiment may be used to identify exposure to methamphetamine manufacture.

In particular embodiments, the hydriodic acid detection agent of the kit may be selected from the group consisting of starch and silver nitrate. In those embodiments wherein said hydriodic acid detection agent is starch, said starch may comprise a starch solution. Said starch solution may have a starch concentration of approximately 1.0 percent starch by weight, approximately 1.5 percent starch by weight, approximately 2.0 percent starch by weight, approximately 2.5 percent starch by weight, approximately 3.0 percent starch by weight, approximately 3.5 percent starch by weight, approximately 4.0 percent starch by weight, approximately 4.5 percent starch by weight, approximately 5.0 percent starch by weight, approximately 5.5 percent starch by weight, or approximately 6.0 percent starch by weight. The starch solution may have a starch concentration within or beyond the stated ranges that are within the scope of this invention.

In those embodiments wherein said hydriodic acid detection agent is silver nitrate, said silver nitrate may comprise a silver nitrate solution. Said silver nitrate solution may have a silver nitrate concentration of approximately 0.50 percent silver nitrate by weight to approximately 4.00 percent silver nitrate by weight. Said silver nitrate solution may have a silver nitrate concentration of approximately 0.50 percent silver nitrate by weight, approximately 1.00 percent silver nitrate by weight, approximately 1.50 percent silver nitrate by weight, approximately 2.00 percent silver nitrate by weight, approximately 2.50 percent silver nitrate by weight, approximately 3.00 percent silver nitrate by weight, approximately 3.50 percent silver nitrate by weight, or approximately 4.00 percent silver nitrate by weight. The silver nitrate solution may have a silver nitrate concentration within or beyond the stated ranges that are within the scope of the present invention.

### EXAMPLES

The following examples are further illustrative of the present invention, but it is understood that the invention is not limited thereto.

Each experiment was designed to test silver nitrate or starch as indicators; glass cleaner with ammonia, distilled water, and isopropyl alcohol as solvents for extracting hydriodic acid from the test item; and the suitability of the above chemicals for testing on different materials.

The experiment required twenty-four test panels. Each panel was approximately two feet by two feet square. In total, there were eight panels each of ½″ plywood (Georgia Pacific), ½″ gypsum board (ProRoc), and ½″ ceiling board (Fifth Avenue 280). It should be noted that although the experiments were conducted using, the above materials, the method and reagents could be effectively used and applied to the testing of virtually any material or item.

Four of each group of eight test panels remained unpainted. Four of each group of eight test panels were primed and painted. Each test panel to be painted was propped vertically. Then, one coat of primer (Color Place Interior Latex Primer) was applied by a paintbrush in vertical columns and then horizontal rows to cover missed areas and border the test panel. These test panels dried for approximately five hours at 65° F. After drying, one coat of paint (Color Place Interior Latex Flat Wall Paint) was applied in vertical columns and horizontal rows by a roller brush to each vertical board. The painted boards were then left for approximately twelve hours to dry at a constant room temperature of 65° F.

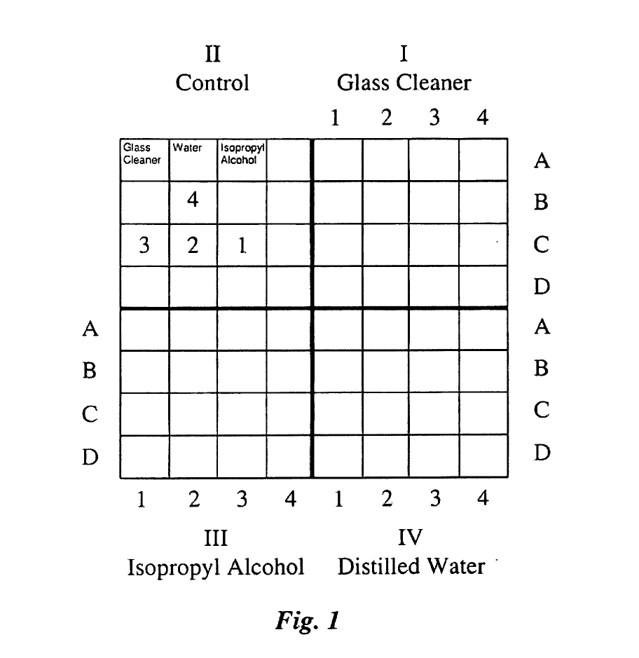

Each test panel, painted or unpainted, was marked in a grid pattern as illustrated in FIG. 1. Thus, each test panel had sixty-four test sections in which each test section was approximately three inches by three inches square. Each panel was then labeled in a manner which allowed for proper reference of each quadrant and each test section of a test panel as illustrated in FIG. 1.

To carry out the experiments, 1.0 molar (M) hydriodic acid (HI) solution was prepared from 47% hydriodic acid (Sigma-Aldrich catalog No. 248649) given solution density of 1.5 g/ml at 25° C. and HI molar weight of 127.9119. Solutions of varying concentration were prepared by dilution of the 1.0 M HI solution. HI solutions used in the experiment had concentrations of about 1.0 M, about 0.1 M, about 0.01 M, and about 0.001 M.

One percent (1.0%) by weight starch solution was prepared by dissolving 1.0 g starch (Fisher Scientific) in distilled water with stirring and heat and then increasing the volume of the solution to 100 mL with distilled water. Two percent (2.0%) by weight starch solution was prepared by dissolving 2.0 g starch (Fisher Scientific) in distilled water with stirring and heat and then increasing the volume of the solution to 100 mL with distilled water. Four percent (4.0%) by weight starch solution was prepared by dissolving 4.0 g starch (Fisher Scientific) in distilled water with stirring and heat and then increasing the volume of the solution to 100 mL with distilled water. Six percent (6.0%) by weight starch solution was prepared by dissolving 6.0 g starch (Fisher Scientific) in distilled water with stirring and heat and then increasing the volume of the solution to 100 mL with distilled water. In some instances, agitation and heating of the starch and distilled water improves solubility of the starch in solution. Heating and agitation may be achieved, for example, on a Fisher Scientific heat plate with magnetic stir bar capability. Various heat levels may be utilized including, for example, heat levels achieved by a mid-level heat setting of the aforementioned heat plate. Similarly, various levels of agitation may be used from low level to high level agitation. Additionally, the heating and agitation may be continued over a time course, such as, for example, heating of the 1.0% by weight starch solution for approximately five minutes, or heating of the other starch solutions for approximately nine minutes. Where appropriate, the aforementioned solutions may be sterilized by autoclave, irradiation, pasteurization or other methods. Moreover, it is anticipated that certain anti-microbial agents, fungicidal agents or other preservatives may be added to any of the above solutions.

One-half percent (0.50%) by weight solution of silver nitrate was prepared by dissolving 0.50 g AgNO₃ (Fisher Scientific) in a final volume of 100 mL of distilled water. One percent (1.00%) by weight solution of silver nitrate was prepared by dissolving 1.00 g AgNO₃ in a final volume of 100 mL of distilled water. Two percent (2.00%) by weight solution of silver nitrate was prepared by dissolving 2.00 g AgNO₃ in a final volume of 100 mL of distilled water. Four percent (4.00%) by weight solution of silver nitrate was prepared by dissolving 4.00 g AgNO₃ in a final volume of 100 mL of distilled water. Where appropriate, the aforementioned solutions may be sterilized by autoclave, irradiation, pasteurization or other methods. Additionally, it is anticipated that certain anti-microbial agents, fungicidal agents or other preservatives may be added to any of the above solutions.

To Quadrants I, II and IV of each test panel, four drops of 0.001 M HI were applied to the center of each test section in each of the “1” columns. To Quadrants I, III and IV of each test panel, four drops of 0.01 M HI were applied to the center of each test section in each of the “2” columns. To Quadrants I, III and IV of each test panel, four drops of 0.1 M HI were applied to the center of each test section in each of the “3” columns. To Quadrants I, III and IV of each test panel, four drops of 1.0 M HI were applied to the center of each test section in each of the “4” columns. Solutions of the above-described concentrations were also applied to the center of each test section corresponding to the numbered squares in Quadrants II (upper left). That is, four drops of 0.001 M HI were applied to the center of the test section in Quadrant II labeled as “1.” Four drops of 0.01 M HI were applied to the center of the test section in Quadrant II labeled as “2.” Four drops of 0.1 M HI were applied to the center of the test section in Quadrant II labeled as “3.” Four drops of 1.0 M HI were applied to the center of the test section in Quadrant II labeled as “4.”

The boards remained undisturbed for approximately twelve hours. Thereafter, two boards of each type (unpainted plywood, painted plywood, unpainted gypsum board, painted gypsum board, unpainted ceiling board, and painted ceiling board) were labeled “Starch.” The remaining twelve boards, equivalent in type to the first set, were labeled “Silver Nitrate.”

The quadrants were each treated separately with solvents to assist in the removal of HI from the test material. For each test material, Quadrant I was tested first. Glass cleaner with ammonia (Great Value) was applied to each test section in Quadrant I. A sample collection device was utilized to collect samples from each test section. In the present embodiment, the sample collection device comprised one quarter section of 18.5 cm Fisherbrand Filter Paper (P8 Qualitative, Coarse Porosity, Fast Flow Rate). The sample collection device was rubbed on each test section for approximately three seconds in a firm, clockwise motion. After this, the sample collection device was placed on an absorbent material, such as, for example, newspaper, in the same configuration corresponding to the appropriate test section as on the test material. As illustration, the sample collected from the test section “A1” of Quadrant I was placed in the upper-left hand corner of the absorbent material corresponding to the similar location of test section “A1” of Quadrant I on the test panel.

Quadrant III was sampled using isopropyl alcohol as the solvent following the aforementioned sample collection procedure. Quadrant IV was sampled using distilled water as the solvent following the aforementioned sample collection procedure. Although solvents may be used in some embodiments of the present invention, use of a solvent may not be necessary for removal of HI under some circumstances. Additionally, some embodiments of the present invention envision the use of alternative solvents including, but not limited to solvents such as, for example, acetone, ethanol and methanol.

When all samples had been collected, a 1.00% starch solution was applied to each sample collection device corresponding to the row labeled as “A” for the samples collected from those test panels labeled “Starch.” Similarly, a 2.00% starch solution was applied to each sample collection device corresponding to the row labeled as “B” for the samples collected from those test panels labeled “Starch.” A 4.00% starch solution was applied to each sample collection device corresponding to the row labeled as “C” for the samples collected from those test panels labeled “Starch.” A 6.00% starch solution was applied to each sample collection device corresponding to the row labeled as “D” for the samples collected from those test panels labeled “Starch.” See FIG. 1.

Silver nitrate solution (0.50%) was applied to each sample collection device corresponding to the row labeled as “A” for the samples collected from those test panels labeled “Silver Nitrate.” Similarly, a 1.00% silver nitrate solution was applied to each sample collection device corresponding to the row labeled as “B” for the samples collected from those test panels labeled “Silver Nitrate.” A 2.00% silver nitrate solution was applied to each sample collection device corresponding to the row labeled as “C” for the samples collected from those test panels labeled “Silver Nitrate.” A 4.00% silver nitrate solution was applied to each sample collection device corresponding to the row labeled as “D” for the samples collected from those test panels labeled “Silver Nitrate.” See FIG. 1.

Quadrant II served as the control. Solvent was applied to the test sections along the topmost side and then rubbed with a sample collection device. See FIG. 1. No indicator was applied to these samples to illustrate that there was no background iodine or iodide contamination. Samples were collected from the four numbered test sections of Quadrant II. Hydriodic acid was applied to test section 1, 2, 3, and 4 of Quadrant II in quantities and concentrations equivalent to the hydriodic acid applied to the rows 1, 2, 3, and 4 of the other quadrants as previously described. Samples were collected from these four test sections without solvent. No indicator was applied to these samples. This controlled for interaction of hydriodic acid with the sample collection devices.

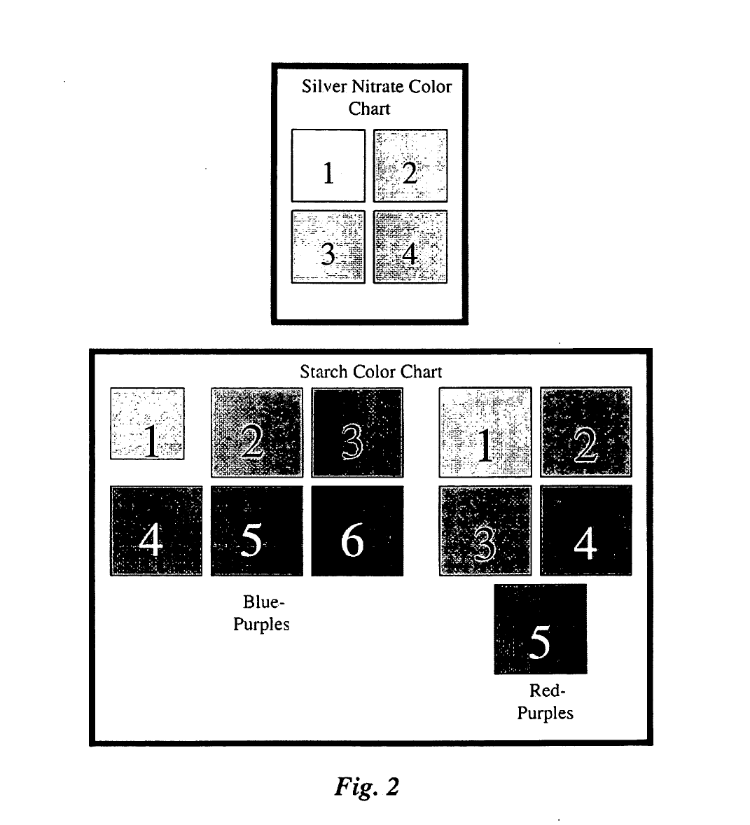

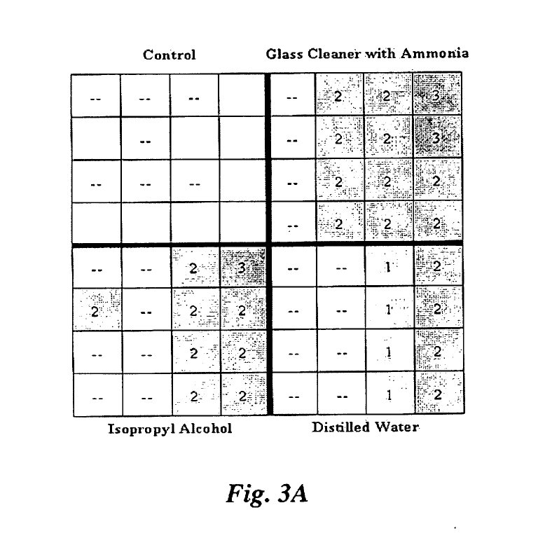

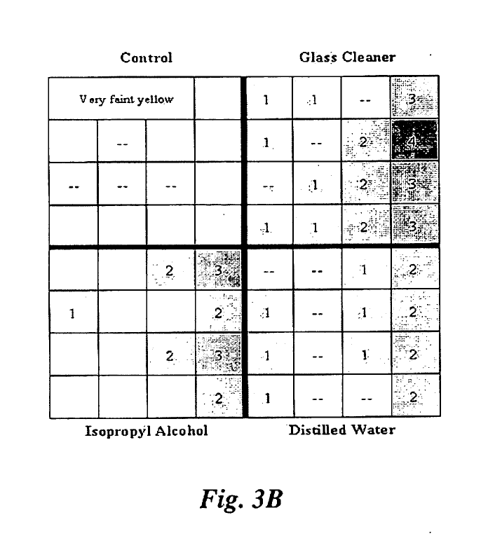

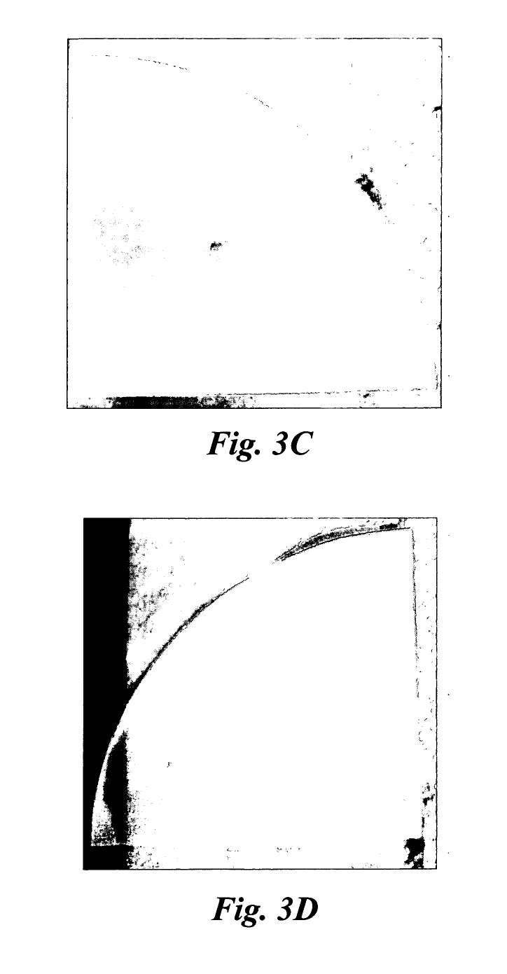

A reference color chart was created from standardized reactions of color indications for both starch and silver nitrate as color indicator reagents. See FIG. 2. All color intensities from collected samples were referenced from this color chart. Next, the average color intensity of the collected samples was analyzed and estimated. The color indications were estimated and designated a numerical intensity based upon the color chart of FIG. 2. The color indications and numerical values were logged graphically. As an example, see FIG. 3.

### EXAMPLE 1

FIGS. 3A and 3B illustrate the results of duplicate tests to detect the presence of hydriodic acid on unpainted plywood using silver nitrate as the indicator. Every concentration of hydriodic acid was detectable. Additionally, each concentration of silver nitrate indicated the presence of hydriodic acid.

FIG. 3C illustrates an exemplary color indication for detection of 0.1M HI on unpainted plywood using distilled water as a solvent and 1.00% silver nitrate as the indicator.

FIG. 3D illustrates an exemplary color indication for detection of 0.01M HI on unpainted plywood using glass cleaner as a solvent and 4.00% silver nitrate as the indicator.

### EXAMPLE 2

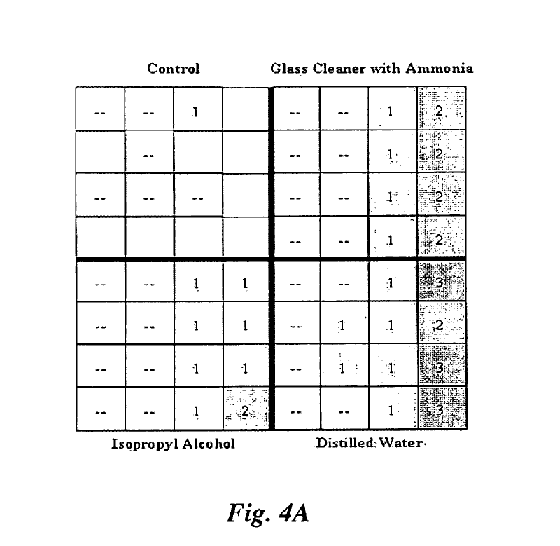

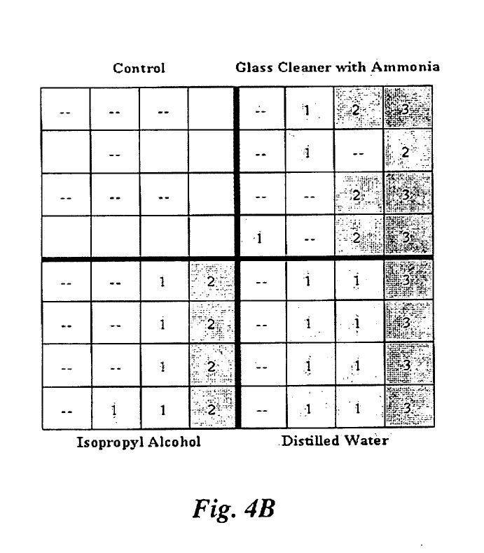

FIGS. 4A and 4B illustrate the results of duplicate tests to detect the presence of hydriodic acid on unpainted sheetrock using silver nitrate as the indicator. Every concentration of hydriodic acid was detectable. Additionally, each concentration of silver nitrate indicated the presence of hydriodic acid.

### EXAMPLE 3

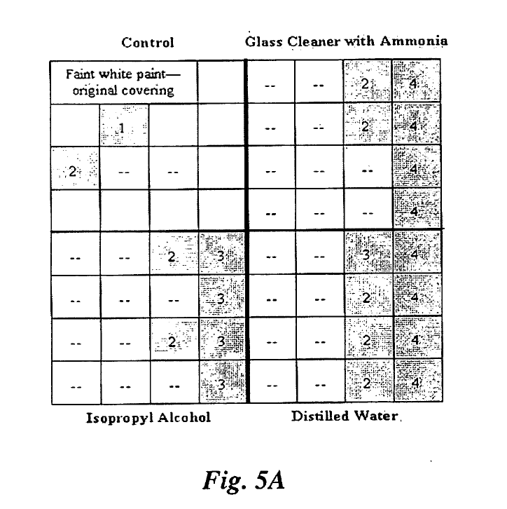

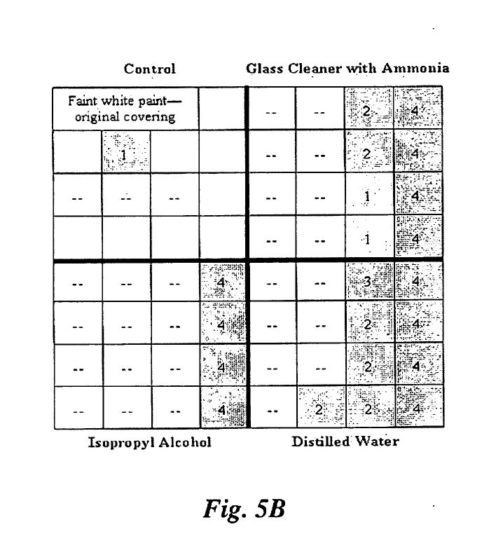

FIGS. 5A and 5B illustrate the results of duplicate tests to detect the presence of hydriodic acid on unpainted ceiling board using silver nitrate as the indicator. Only the lowest concentration of hydriodic acid was not detectable. However, each concentration of silver nitrate indicated the presence of hydriodic acid.

### EXAMPLE 4

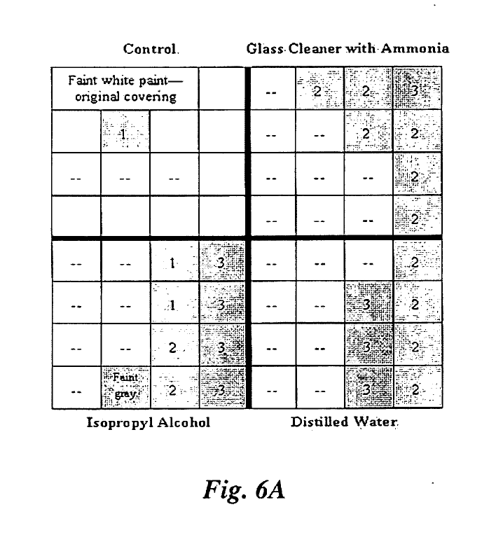

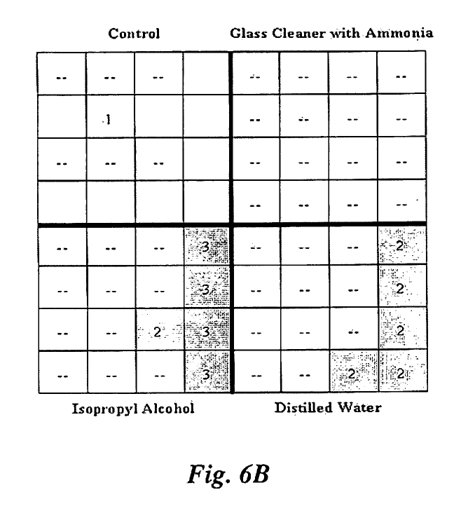

FIGS. 6A and 6B illustrate the results of duplicate tests to detect the presence of hydriodic acid on painted plywood using silver nitrate as the indicator. Only the lowest concentration of hydriodic acid was not detectable. However, each concentration of silver nitrate indicated the presence of hydriodic acid.

### EXAMPLE 5

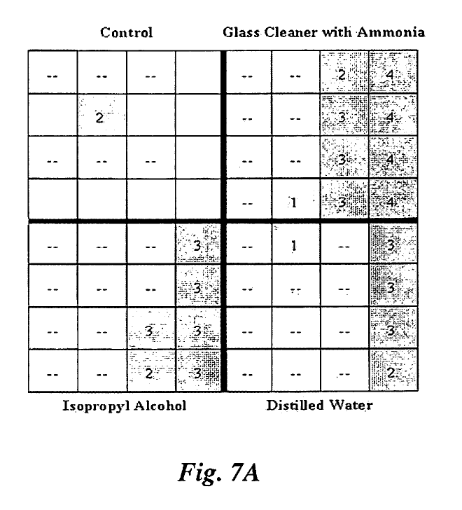

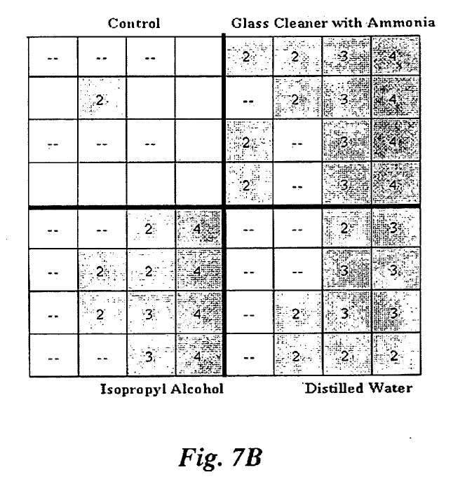

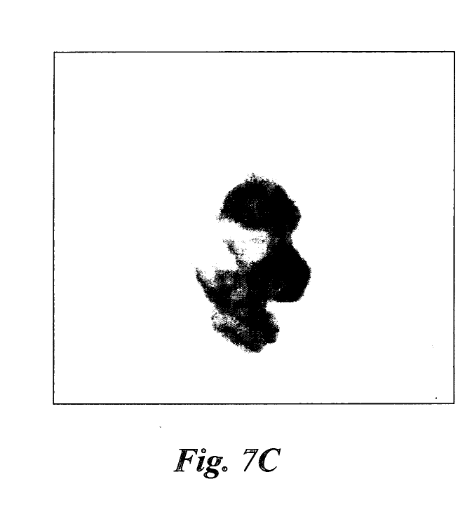

FIGS. 7A and 7B illustrate the results of duplicate tests to detect the presence of hydriodic acid on painted sheetrock using silver nitrate as the indicator. Every concentration of hydriodic acid was detectable. Additionally, each concentration of silver nitrate indicated the presence of hydriodic acid.

FIG. 7C illustrates an exemplary color indication for detection of 1.0M HI on painted sheetrock using isopropyl alcohol as a solvent and 0.50% silver nitrate as the indicator.

### EXAMPLE 6

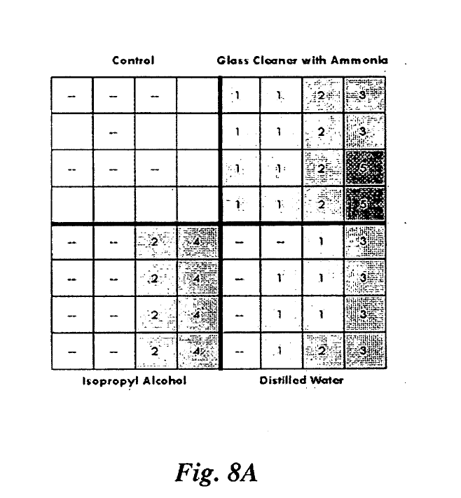

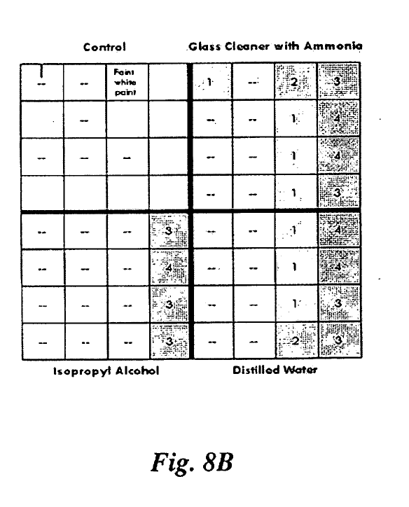

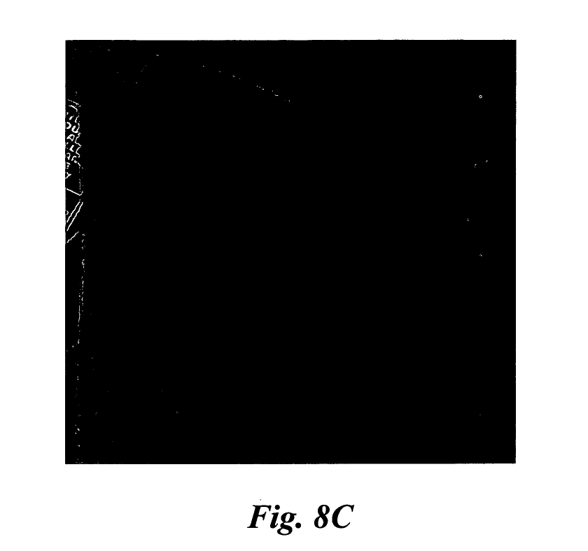

FIGS. 8A and 8B illustrate the results of duplicate tests to detect the presence of hydriodic acid on painted ceiling board using silver nitrate as the indicator. Every concentration of hydriodic acid was detectable. Additionally, each concentration of silver nitrate indicated the presence of hydriodic acid.

FIG. 8C illustrates an exemplary color indication for detection of 1.0M HI on painted ceiling board using distilled water as a solvent and 0.50% silver nitrate as the indicator.

### EXAMPLE 7

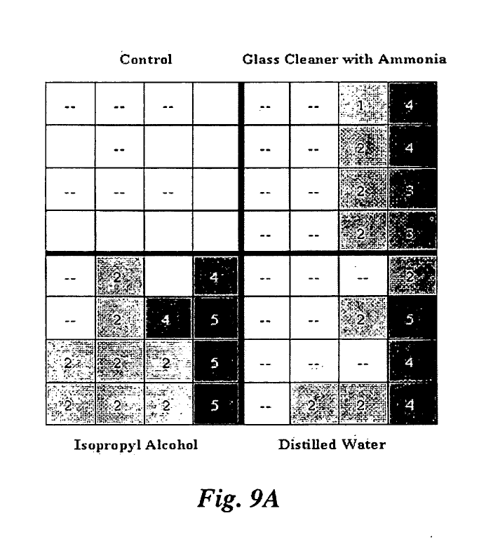

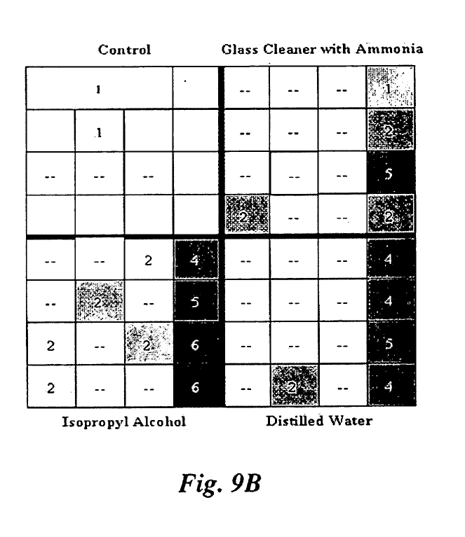

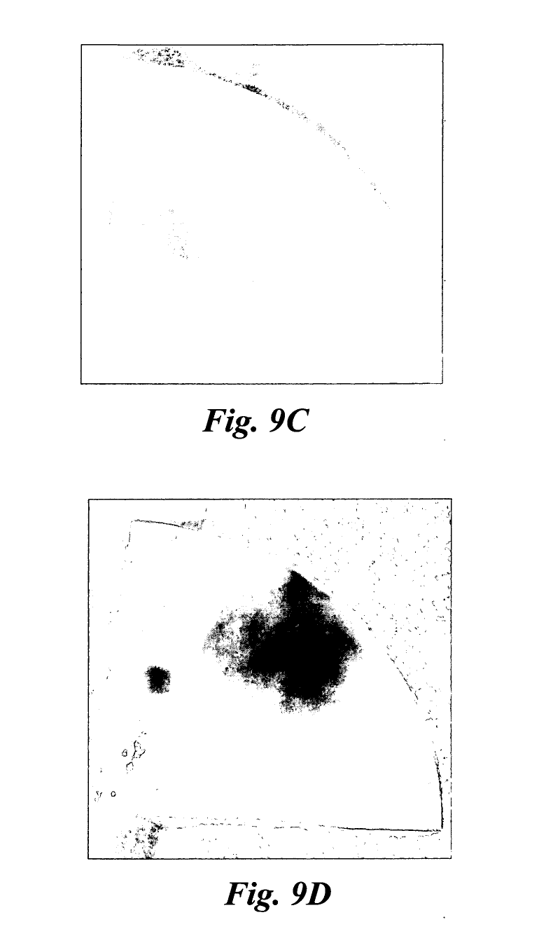

FIGS. 9A and 9B illustrate the results of duplicate tests to detect the presence of hydriodic acid on unpainted plywood using starch as the indicator. Every concentration of hydriodic acid was detectable. Additionally, each concentration of starch indicated the presence of hydriodic acid.

FIG. 9C illustrates an exemplary color indication for detection of 0.1M HI on unpainted plywood using isopropyl alcohol as a solvent and 4.00% starch as the indicator.

FIG. 9D illustrates an exemplary color indication for detection of 1.0M HI on unpainted plywood using distilled water as a solvent and 2.00% starch as the indicator.

### EXAMPLE 8

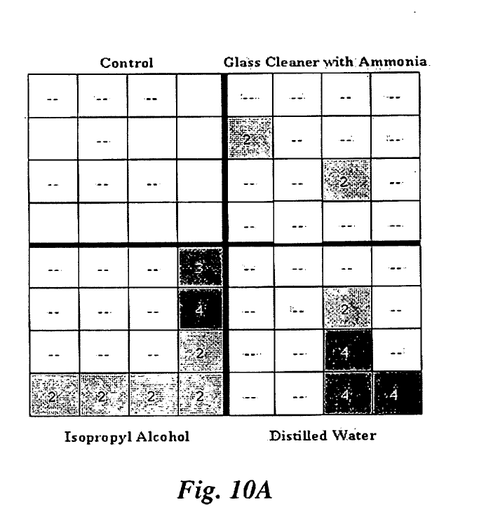

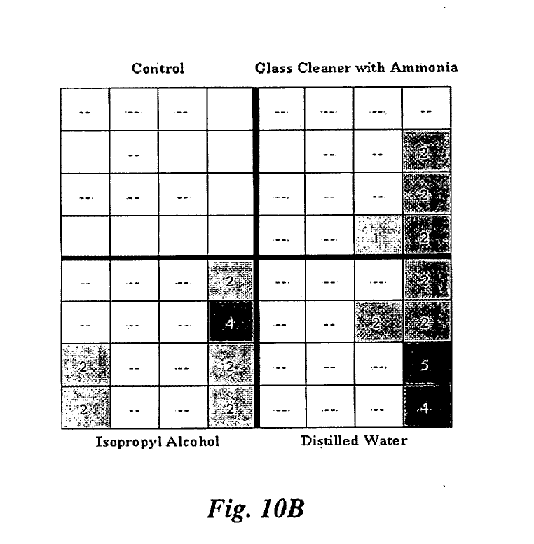

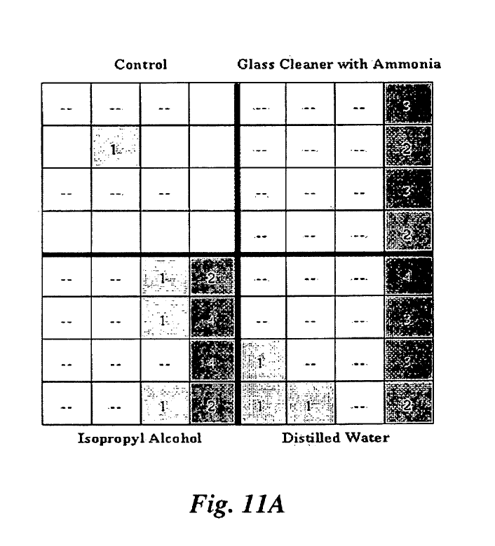

FIGS. 10A and 10B illustrate the results of duplicate tests to detect the presence of hydriodic acid on unpainted sheetrock using starch as the indicator. Every concentration of hydriodic acid was detectable. Additionally, each concentration of starch indicated the presence of hydriodic acid.

### EXAMPLE 9

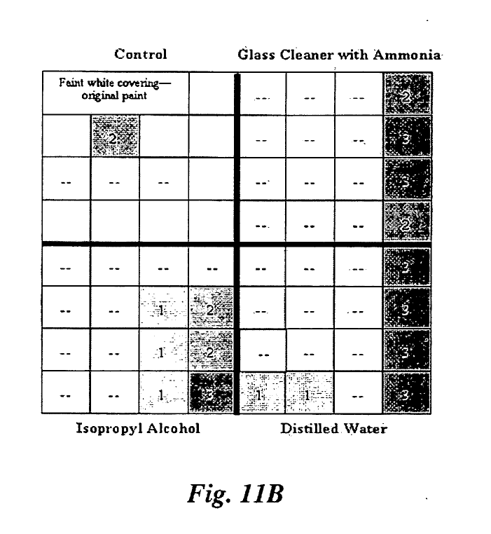

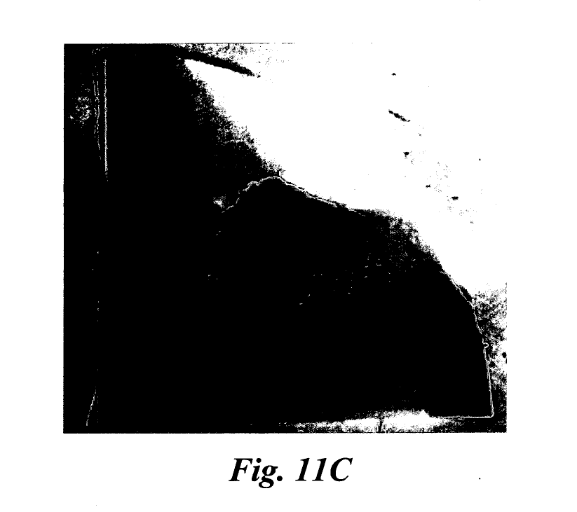

FIGS. 11A and 11B illustrate the results of duplicate tests to detect the presence of hydriodic acid on unpainted ceiling board using starch as the indicator. Every concentration of hydriodic acid was detectable. Additionally, each concentration of starch indicated the presence of hydriodic acid.

FIG. 11C illustrates an exemplary color indication for detection of 1.0M HI on unpainted ceiling board using isopropyl alcohol as a solvent and 6.00% starch as the indicator.

### EXAMPLE 10

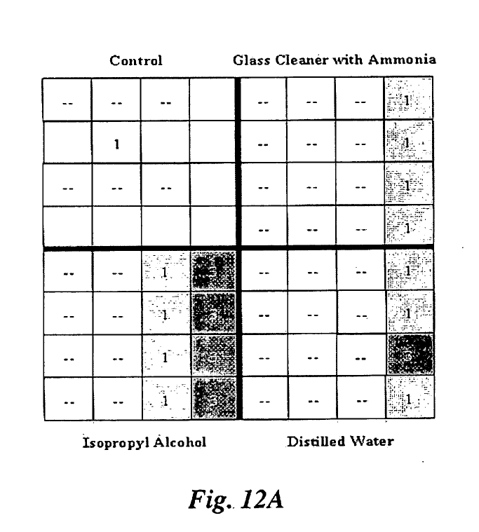

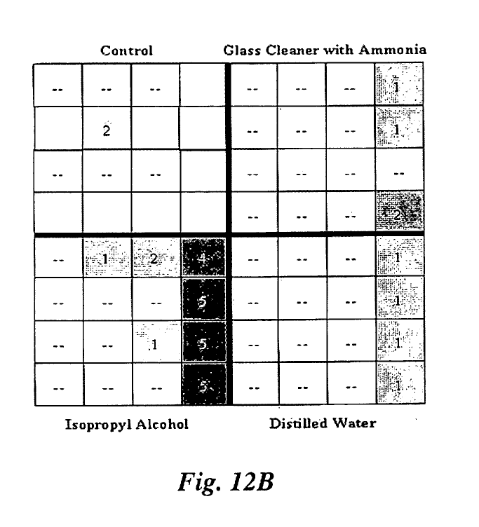

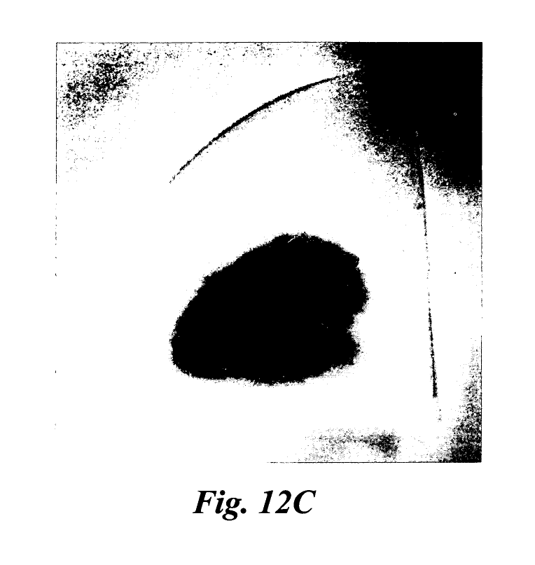

FIGS. 12A and 12B illustrate the results of duplicate tests to detect the presence of hydriodic acid on painted plywood using starch as the indicator. Only the lowest concentration of hydriodic acid was not detectable. However, each concentration of starch indicated the presence of hydriodic acid.

FIG. 12C illustrates an exemplary color indication for detection of 1.0M HI on painted plywood using isopropyl alcohol as a solvent and 6.00% starch as the indicator.

### EXAMPLE 11

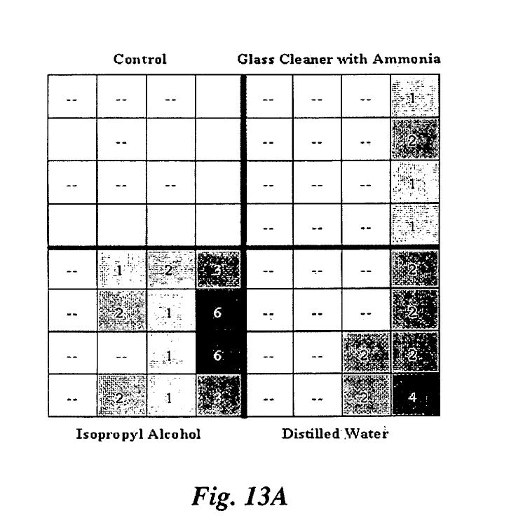

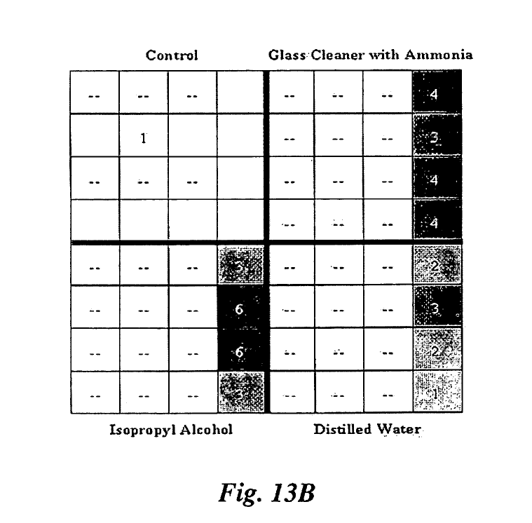

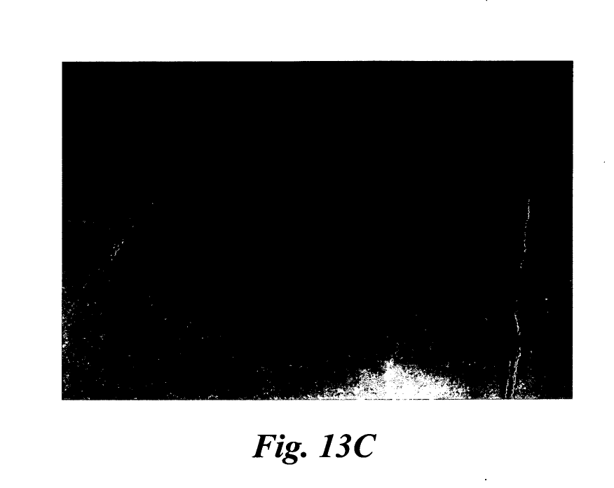

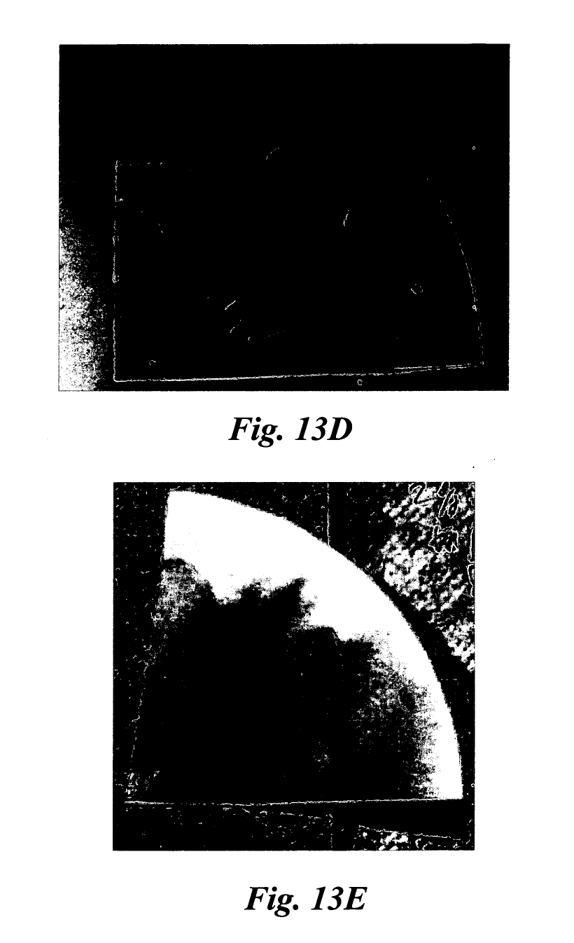

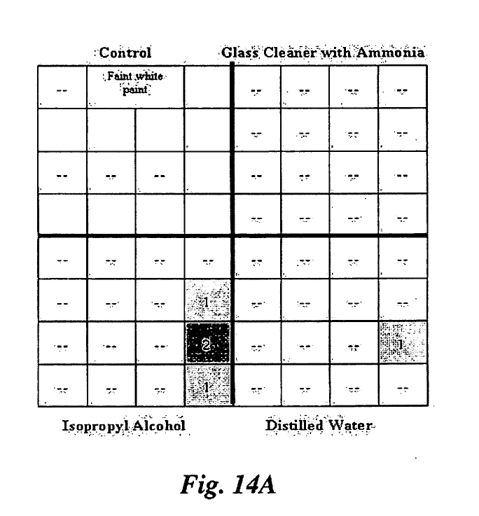

FIGS. 13A and 13B illustrate the results of duplicate tests to detect the presence of hydriodic acid on painted sheetrock using starch as the indicator. Only the lowest concentration of hydriodic acid was not detectable. However, each concentration of starch indicated the presence of hydriodic acid.

FIG. 13C illustrates an exemplary color indication for detection of 1.0M HI on painted sheetrock using distilled water as a solvent and 2.00% starch as the indicator.

FIG. 13D illustrates an exemplary color indication for detection of 1.0M HI on painted sheetrock using isopropyl alcohol as a solvent and 4.00% starch as the indicator.

FIG. 13E illustrates an exemplary color indication for detection of 0.01M HI on painted sheetrock using isopropyl alcohol as a solvent and 2.00% starch as the indicator.

### EXAMPLE 12

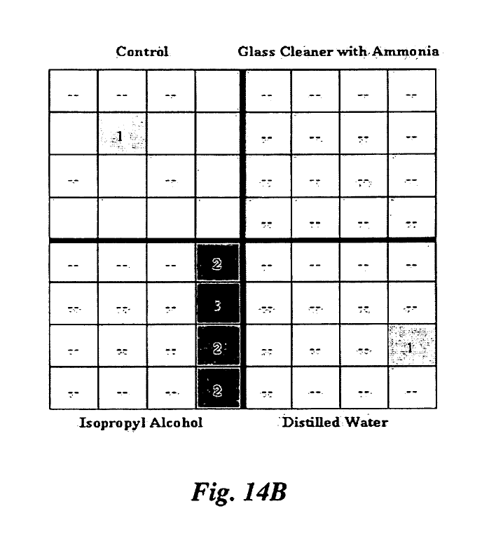

FIGS. 14A and 14B illustrate the results of duplicate tests to detect the presence of hydriodic acid on painted ceiling board using starch as the indicator. Only the highest concentration of hydriodic acid was detectable. However, each concentration of starch indicated the presence of hydriodic acid.

Overall, starch is a more economical indicator and has a greater range of colors than silver nitrate. However, silver nitrate is very sensitive to hydriodic acid, often indicating at the lowest value tested, 0.001 M HI.

As various changes could be made in the above methods and compositions without departing from the scope of the invention, it is intended that all matter contained in the above description be interpreted as illustrative and not in a limiting sense. Unless explicitly stated to recite activities that have been done (i.e., using the past tense), illustrations and examples are not intended to be a representation that given embodiments of this invention have, or have not, been performed.

What is claimed is:

1. A reagent for detecting exposure to drug manufacture comprising a hydriodic acid detection agent.

2. The reagent of claim 1 wherein said hydriodic acid detection agent is selected from the group consisting of starch and silver nitrate.

3. The reagent of claim 2 wherein said starch comprises a starch solution.

4. The reagent of claim 3 wherein said starch solution has a starch concentration in the range of approximately 1.0 percent starch by weight to approximately 6.0 percent starch by weight.

5. The reagent of claim 2 wherein said silver nitrate comprises a silver nitrate solution.

6. The reagent of claim 5 wherein said silver nitrate solution has a silver nitrate concentration of approximately 0.50 percent silver nitrate by weight to approximately 4.00 percent silver nitrate by weight.

7. The reagent of claim 1 wherein said drug manufacture is methamphetamine manufacture.

8 A method of detecting exposure of an item to drug manufacture comprising detecting hydriodic acid in or on said item.

9. The method of claim 8 further comprising obtaining a sample from said item.

10. The method of claim 9 wherein obtaining a sample from said item comprises contacting a solvent with the item.

11. The method of claim 10 wherein said solvent is selected from the group consisting of distilled water, isopropyl alcohol, acetone, ethanol, methanol, and household glass cleaner.

12. The method of claim 9 wherein a regent for detecting exposure to drug manufacture is contacted with the sample.

13. The method of claim 12 wherein said reagent for detecting exposure to drug manufacture comprises a hydriodic acid detection agent.

14. The method of claim 13 wherein said hydriodic acid detection agent is selected from the group consisting of starch and silver nitrate.

15. The method of claim 14 wherein said starch comprises a starch solution.

16. The method of claim 15 wherein said starch solution has a starch concentration in the range of approximately 1.0 percent starch by weight to approximately 6.0 percent starch by weight.

17. The method of claim 14 wherein said silver nitrate comprises a silver nitrate solution.

18. The method of claim 17 wherein said silver nitrate solution has a silver nitrate concentration in the range of approximately 0.50 percent silver nitrate by weight to approximately 4.00 percent silver nitrate by weight.

19. The method of claim 12 wherein contacting the sample with the reagent for detecting exposure to drug manufacture results in the development of a color indicator, such that development of a color indicator is indicative of exposure of the item sampled to drug manufacture.

20. The method of claim 8 wherein said drug manufacture is methamphetamine manufacture.
